(19) United States
(12) Patent Application Publication
(10) Pub. No.: US 2026/0244638 A1
(43) Pub. Date: Aug. 20, 2026

(54) TECHNIQUES FOR PERFORMING OFFLINE TO ONLINE DATA MOVEMENTS

(71) Applicant: NETFLIX, INC., Los Gatos, CA (US)

(72) Inventor: Kenneth Alexander KURZWEIL, Foster City, CA (US)

(21) Appl. No.: 19/355,807

(22) Filed: Oct. 10, 2025

Related U.S. Application Data
(60) Provisional application No. 63/761,046, filed on Feb. 20, 2025.

(51) Int. Cl. G06F 16/25

(52) U.S. Cl. CPC G06F 16/258

(57) ABSTRACT

One embodiment sets forth a technique for deploying offline datasets for online access. According to some embodiments, the technique can include the steps of generating, at a server device, a captured dataset based on a user dataset of a user device, wherein the captured dataset is configured in a first format, generating, at the server device, a converted dataset based on the captured dataset, wherein the converted dataset is configured in a second format, and causing, at the server device, the converted dataset to be deployed on a target cluster having a native format comprising the second format, wherein the server device is separate from the user device and the target cluster.

### CROSS-REFERENCE TO RELATED APPLICATIONS

The present application claims the benefit of U.S. Provisional Application titled, “TECHNIQUES FOR PERFORMING OFFLINE TO ONLINE DATA MOVEMENTS”, filed on Feb. 20, 2025, and having Ser. No. 63/761,046. The subject matter of this related application is hereby incorporated herein by reference.

### BACKGROUND

### Field of the Various Embodiments

Embodiments of the present disclosure relate generally to computer science and computer networks, and more specifically, to techniques for performing offline to online data movements (OODMs).

### Description of the Related Art

In the current landscape of data management, there is an increasing demand exists for efficient methods to transition offline-generated user datasets to online datastores, referred to as target nodes, that are accessible to clients. This necessity arises from the requirement for clients to access and utilize these datasets promptly and reliably. User datasets can encompass a wide range of data types and are often stored in specific dataset formats, such as Parquet or Iceberg tables. Modern user datasets frequently reach terabytes in size. A user device generates and manages the user dataset, which can be stored locally at the user device or in cloud storage via one or more cloud servers.

A challenge lies in efficiently transitioning these large datasets from offline storage to online access points, known as target nodes, that are responsible for deploying and hosting the datasets while managing client requests for accessing the datasets. Each particular target node is configured to deploy and host user datasets in a specific native format, such that any user dataset must be in the native format of the particular target node. However, the original format of the user dataset typically differs from the native format of a target node. Conventional approaches for moving an offline dataset to an online target node include the user device loading the dataset onto the target node via front-end application programming interfaces (APIs) of the target node that read and write data from the dataset to the target node.

One drawback of the conventional approaches is that the processing performed by the front-end APIs of the target node also requires a format conversion from the dataset format to the native format of the target node. Format conversion operations are especially computationally intensive and consume significant computing resources of the target node. As a result, the primary functions of the target node, such as servicing client requests and managing other datasets, can be significantly impacted and slowed down. Moreover, the front-end APIs of the target node process the dataset in a piecemeal fashion, whereby small portions of the dataset are converted and then deployed on the target node, which is a slow and time-consuming process for large datasets. Similarly, the user device experiences prolonged consumption of computing resources since it must interact with the target node throughout the process until the dataset loading is successfully completed.

Another drawback of the conventional approaches is that the heavy additional workload on the target node increases the risk of dataset loading failure to the target node. When the dataset fails to upload, a complete restart of the process is required, whereby the user device must attempt to reload the dataset from the beginning, further extending the period during which the computing resources of the target node and user device are expended.

A further drawback of conventional approaches is that, if the user dataset is successfully loaded and deployed on the target node and errors are subsequently found in the deployed user dataset, the deployed user dataset cannot be easily rolled back to an earlier version of the user dataset, as the user typically does not retain previous versions. Consequently, the user device cannot simply load and deploy onto the target node an earlier version of the user dataset that did not contain any errors. Instead, the user device must identify all errors in the current user dataset, remove the identified errors to generate a modified user dataset, and reload and redeploy the modified user dataset to the target node. Such a recovery process consumes computing resources of the consumer device and target node over an extended time.

As the foregoing illustrates, what is needed in the art are more effective techniques for performing offline to online data movements (OODMs).

### SUMMARY

One embodiment sets forth a computer-implemented method for deploying offline datasets for online access. According to some embodiments, the method includes the steps of generating, at a server device, a captured dataset based on a user dataset of a user device, wherein the captured dataset is configured in a first format, generating, at the server device, a converted dataset based on the captured dataset, wherein the converted dataset is configured in a second format, and causing, at the server device, the converted dataset to be deployed on a target cluster having a native format comprising the second format, wherein the server device is separate from the user device and the target cluster.

Other embodiments of the present disclosure include, without limitation, one or more computer-readable media including instructions for performing one or more aspects of the disclosed techniques as well as a computing device for performing one or more aspects of the disclosed techniques.

One technical advantage of the disclosed techniques relative to the prior art is that the disclosed techniques significantly reduce the processing workload and time required by the user device and the cluster in transferring the offline user dataset to an online cluster. In particular, the OODM server interacts with the user device only to capture a snapshot image of the user dataset, which requires negligible computing resources and time from the user device. The OODM server subsequently performs the processing-intensive conversion of the captured dataset to the native format of the cluster without necessitating any processing or interactions by the user device or the cluster. Given that the user dataset is already converted to the native format of the cluster, the converted dataset can be rapidly and efficiently deployed to the cluster with minimal additional processing executed by the back-end APIs of the cluster. As such, the workload on the cluster is greatly reduced relative to prior approaches, thereby ensuring that the cluster can perform base functions in serving other datasets to clients without interference and slowdown.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates an offline to online data movement (OODM) system configured to implement one or more aspects of the various embodiments;

FIG. 2 shows a conceptual illustration of a OODM processing pipeline implemented by the OODM system of FIG. 1, according to various embodiments;

FIG. 3 shows a conceptual illustration of a partitioning process during the conversion phase of the processing pipeline of FIG. 2, according to various embodiments;

FIG. 4 sets forth a flow diagram of method steps for performing one or more phases of the OODM processing pipeline, according to various embodiments;

FIG. 5 sets forth a flow diagram of method steps for performing the capture phase of the OODM processing pipeline, according to various embodiments;

FIG. 6 sets forth a flow diagram of method steps for performing the conversion phase of the OODM processing pipeline, according to various embodiments;

FIG. 7 sets forth a flow diagram of method steps for performing the deployment phase of the OODM processing pipeline, according to various embodiments; and

FIG. 8 is a conceptual illustration of a computing device that can be used to implement any of the computing devices shown in FIG. 1, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

As described, there is a growing need for efficient methods to transition offline-generated user datasets that are not accessible to clients via a network to online datastores (target nodes) that are accessible to clients via a network. User datasets exist in original dataset/database formats and often reach terabytes in size. User datasets are generated and managed by user devices and can be stored locally or in cloud storage. A challenge involves efficiently transitioning these large datasets to target nodes that deploy, host, and manage client access to user datasets. However, each target node requires its hosted datasets to be configured in a specific native dataset/database format that usually differs from the original format of user datasets. Conventional methods involve loading user datasets onto target nodes via front-end APIs to read, write, and convert the original format of user datasets to the native format of target nodes. This process is computationally intensive for target nodes, consuming significant resources for extended periods and slowing down primary functions such as servicing client requests for other hosted datasets. Additionally, the heavy workload on target nodes increases the risk of failure, requiring a complete restart if a user dataset fails to upload, further extending resource usage of target nodes and user devices. Furthermore, if errors are subsequently found in deployed datasets, a rollback to previous versions of user datasets is difficult, as user devices typically do not retain previous versions.

The disclosed techniques set forth an offline to online data movement (OODM) system for efficiently moving offline-generated user datasets to online datastores accessible by clients. The OODM system includes an OODM server executing an OODM application that interacts, via a network, with both a user device associated with a user dataset and a cluster of target nodes deploying the user dataset to provide online access to clients. The OODM server provides a processing pipeline between the user device and the cluster of target nodes to capture and convert a user dataset for rapid and efficient deployment on the cluster of target nodes. In particular, the OODM application provides a processing pipeline that performs three separate and independent phases, including a capture phase, a conversion phase, and a deployment phase. In the capture phase, the OODM application interacts with the user device to capture an immutable (read-only) snapshot image of the user database to generate a captured dataset. In the conversion phase, the OODM application converts the captured dataset to the native format of the cluster of target nodes to generate a converted dataset. In the deployment phase, the OODM application interacts with the cluster of target nodes using back-end APIs to deploy the converted dataset on the cluster to provide a deployed dataset that clients can access via a network. All three phases can be performed automatically, or each phase can be performed separately and independently if needed.

One technical advantage of the disclosed techniques relative to the prior art is that the disclosed techniques significantly reduce the processing workload and time required by the user device and the cluster in moving the offline user dataset to an online cluster. In particular, the OODM server interacts with the user device only to capture a snapshot image of the user dataset, which requires negligible computing resources and time of the user device. The OODM server then performs the processing-intensive conversion of the captured dataset to the native format of the cluster without requiring any processing or interactions by the user device or the cluster. Since the user dataset is already converted to the native format of the cluster, the converted dataset can be rapidly and efficiently deployed to the cluster with minimal additional processing by the back-end APIs of the cluster. As such, the workload on the cluster is greatly reduced relative to prior approaches so that the cluster can perform its base functions serving other datasets to clients without interference and slowdown.

Another technical advantage of the disclosed techniques relative to the prior art is that the disclosed techniques provide a processing pipeline that does not require all three phases to be performed sequentially, thereby allowing each separate phase to be performed independently and repeatedly when needed. This flexibility is valuable for generating snapshots of different versions of a user dataset at varying points in time, converting a captured dataset to a different native format, or deploying a converted dataset to another cluster. Another technical advantage of the disclosed techniques relative to the prior art is that the disclosed techniques provide the ability to independently perform the deployment phase, thereby enabling the redeployment of a converted dataset to the same cluster upon failure of a previous deployment, without restarting the data movement process as required in prior approaches. Another technical advantage of the disclosed techniques relative to the prior art is that the disclosed techniques capture and retain different versions of a user dataset at different points in time, thereby providing rapid and efficient rollback to a prior version of a user dataset if errors are found in a current version.

### System Overview

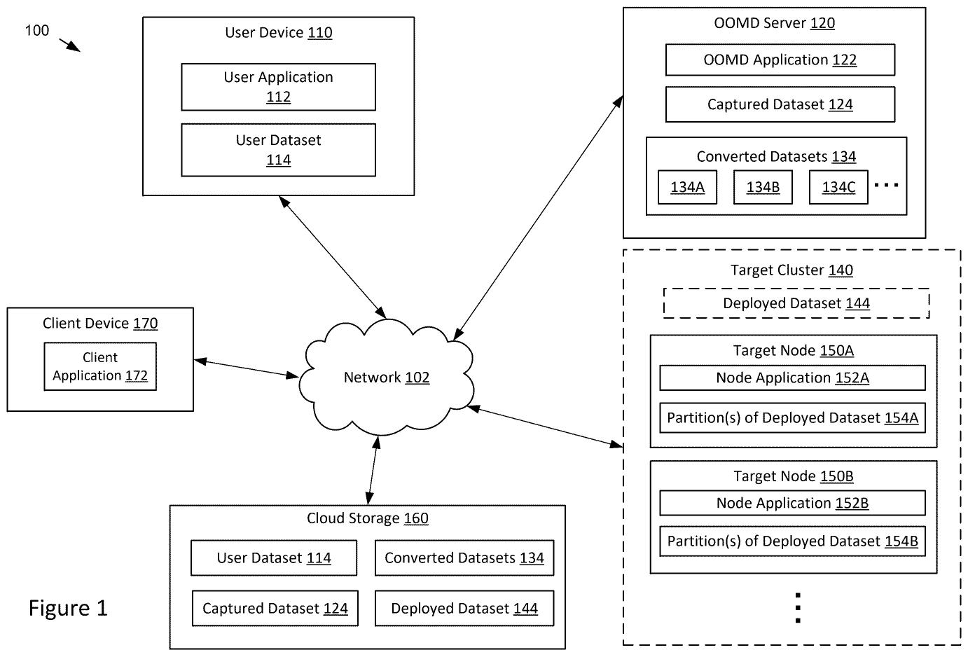

FIG. 1 illustrates an offline to online data movement (OODM) system 100 configured to implement one or more aspects of the various embodiments. The OODM system 100 comprises multiple interconnected devices and servers that facilitate a capture phase, conversion phase, and/or deployment phase applied to the user datasets. The OODM system 100 includes a network 102 that interconnects and enables communications between various components, including a user device 110, an OOMD server 120, a target cluster 140 comprising a set of target nodes 150, a cloud storage 160, and at least one client device 170. In some embodiments, the OOMD server 120 is a separate and independent computing device from both the user device 110 and the target cluster 140. In these embodiments, the OOMD server 120 comprises separate and independent processor and/or memory components from both the user device 110 and the target cluster 140. For the sake of illustration, OODM operations are described for processing only one version of a user dataset associated with a single time point. However, in other embodiments, multiple versions of the user dataset associated with different time points can be processed in a similar manner as described herein.

The network 102 can represent, for example, any technically feasible network or number of networks, including a wide area network (WAN) such as the Internet, a local area network (LAN), a Wi-Fi network, a cellular network, or a combination thereof.

The user device 110 comprises a computing device that executes a user application 112 that generates and manages a user dataset 114. In some embodiments, the data of the user dataset 114 includes a plurality of records, each record contains a plurality of unique items comprising key-value pairs. The data of the user dataset 114 is configured/arranged in an original format, such as Parquet or Iceberg tables. The user dataset 114 can be stored locally at the user device 110 or stored remotely in cloud storage 160.

The user application 112 can comprise a web-browser with an API that enables interactions with the OODM server 120. The user application 112 can transmit, via the network 102, requests to the OODM server 120 that some type of action relating to the user dataset 114 be performed. For example, the user application 112 can transmit, via the network 102, a request to the OODM server 120 that the user dataset 114 be deployed onto a target cluster 140 (online datastore) using a particular deployment configuration for providing online access to the user dataset 114. As another example, the user application 112 can transmit a request to the OODM server 120 that the user dataset 114 be redeployed onto a different target cluster 140 using the same deployment configuration or a different deployment configuration. The OODM server 120 will then respond to the user request by executing one or more of the capture phase, conversion phase, and/or deployment phase to satisfy the user request.

The OOMD server 120 can comprise a single computing device (such as a server system or node) or multiple computing devices (such as multiple server systems or multiple nodes). In some embodiments, the OOMD server 120 is a separate and independent computing device from both the user device 110 and the target cluster 140. In these embodiments, the OOMD server 120 comprises separate and independent processor and/or memory components from both the user device 110 and the target cluster 140. The OOMD server 120 executes an OOMD application 122 that interacts with the user device 110 and/or target cluster 140 to perform one, two, and/or three distinct phases of the OODM processing pipeline as needed based on a specific situation or to satisfy/respond to a received user request. The three phases of the OODM processing pipeline include a capture phase, conversion phase, and deployment phase. For example, the OOMD application 122 can reperform only the deployment phase when a prior deployment of a user dataset 114 to a target cluster 140 has failed. As another example, the OOMD application 122 can automatically perform all three phases in sequence to respond to a user request that the user dataset 114 be deployed for online access to clients 170.

In the capture phase, the OOMD application 122 generates a snapshot image of the user dataset 114 to generate a captured dataset 124. The captured dataset 124 can be stored locally at the OOMD server 120 or stored remotely in cloud storage 160. The captured dataset 124 comprises an unmodifiable/immutable (read-only) capture of the user dataset 114 having an associated timestamp indicating a time point when the user dataset 114 was captured and the captured dataset 124 was generated. Although the data in the captured dataset 124 will not change at any time, the user dataset 114 managed by the user device 110 will typically continue to change, thereby creating new/different versions of the user device 110 associated with new/different time points. The OOMD application 122 can capture each new/different version of the user device 110 to generate a new/different captured dataset 124 having a new/different associated timestamp. In some embodiments, a version number of a particular captured dataset 124 comprises the timestamp associated with the particular captured dataset 124.

In the conversion phase, the OOMD application 122 processes the captured dataset 124 to generate one or more one converted datasets 134 (such as 134A, 134B, 134C, etc.) based on a particular deployment configuration. The one or more one converted datasets 134 can be stored locally at the OOMD server 120 or stored remotely in cloud storage 160. A deployment configuration includes a set of deployment parameters (such as a native format of the target cluster 140, a number of desired partitions, etc.) that are selected/configured for a specific deployment situation. Each different set of deployment parameters specifies a different deployment configuration that is used by the OOMD application 122 to generate a different converted dataset 134 (such as 134A, 134B, 134C, etc.) for a specific target cluster 140. In particular, the OOMD application 122 converts the captured dataset 124 to the native format of the target cluster 140 to which the converted dataset 134 is to be deployed. Note that the target nodes 150 that are selected for inclusion in a particular target cluster 140 are selected to have the same native format, resulting in a target cluster 140 having a same associated native format.

In the deployment phase, the OOMD application 122 interacts with the specific target cluster 140 to cause the converted dataset 134 to be deployed on the specific target cluster 140, at which point the converted dataset 134 is referred to as a deployed dataset 144. The target cluster 140 includes a set of one or more target nodes 150 (such as 150A, 150B, etc.) that collectively deploy and host a deployed dataset 144 to provide online access to data of the deployed dataset 144 to one or more client devices 170. The deployed dataset 144 can be stored locally at the target cluster 140 or stored remotely in cloud storage 160. The deployed dataset 144 is divided into a set of partitions 154 (such as 154A, 154B, etc.), each partition 154 being assigned to a particular target node 150 in the target cluster 140. Each target node 150 comprises a computing device that executes a node application 152 (such as 152A, 152B, etc.) that deploys and hosts at least one partition of a deployed dataset 154 (such as 154A, 154B, etc.). For the sake of clarify, the target cluster 140 and the deployed dataset 144 are generally referred to in the description below, whereby the individual target nodes 150 of the target cluster 140 and the individual partitions of the user dataset 114 are discussed when relevant.

Since the converted dataset 134 is already formatted in the native format of the target cluster 140, the converted dataset 134 can be rapidly and efficiently deployed on the target cluster 140 as the deployed dataset 144 using back-end APIs of the target cluster 140 that only need to perform minimal processing operations on the converted dataset 134 to launch/establish the deployed dataset 144 on the target cluster 140, which is then instantly available for online access. In particular, each target node 150 can rapidly and efficiently deploy at least one partition of the deployed dataset 154 using back-end APIs of the target node 150 that only need to perform minimal processing operations on the converted dataset 134 to launch/establish the at least one partition of the deployed dataset 154 for online access. In this regard, the node application 152 at each target node 150 can begin servicing client requests for data of the at least one partition of the deployed dataset 154.

The cloud storage 160 can include one or more cloud servers that serve as a repository for various datasets, such as the user dataset 114, the captured dataset 124, the converted datasets 134, and the deployed dataset 144. The client device 170 executes a client application 172 that interacts with the target cluster 140 to access data of the deployed dataset 144 via the network 102. In FIG. 1, only one client device 170 is shown, but in other embodiments, the system 100 includes a plurality of client devices 170.

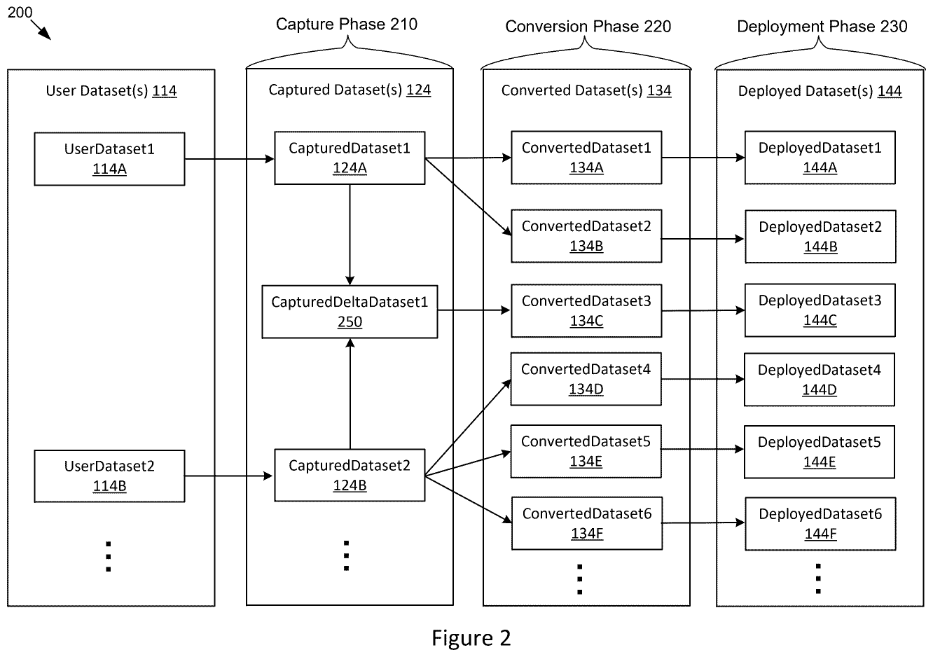

FIG. 2 shows a conceptual illustration of a OODM processing pipeline 200 implemented by the OODM system 100 of FIG. 1, according to various embodiments. As shown, the OODM processing pipeline 200 includes a capture phase 210, a conversion phase 220, and a deployment phase 230.

In the capture phase 210, the OOMD application 122 executing on the OOMD server 120 generates a captured dataset 124 for each version of the user dataset 114. Subsequently, the user dataset 114 will continually be modified so that different versions of the user dataset 114 will exist at different time points, such as the first version of the user dataset UserDataset1 114A, followed by the second version of the user dataset UserDataset2 114B, and so forth. As new versions of the user dataset 114 are generated, the user application 112 can request deployments of some of the new versions of the user dataset 114 to a target cluster 140 using some type of trigger/initiating mechanism. For example, in some embodiments, the user application 112 can schedule a deployment request to be sent to the OOMD application 122 at predetermined time intervals for the current version of the user dataset 114 to be deployed on a target cluster 140, which will initiate the OOMD application 122 to automatically perform the capture phase 210 to generate a snapshot of the current version of the user dataset 114, followed by the conversion phase 220 and the deployment phase 230. In other embodiments, the user application 112 can transmit the deployment request to the OOMD application 122 based on another trigger mechanism, such as upon determining that the user dataset 114 has been modified by a predetermined data amount, or another other type of trigger mechanism. Users typically configure the criteria for which such deployment triggers occurs.

As shown, the OOMD application 122 can generate a snapshot of the first version of the user dataset UserDataset1 114A to generate a first captured dataset CapturedDataset1 124A, than later generate another snapshot of the second version of the user dataset UserDataset2 114B to generate a second captured dataset CapturedDataset2 124B, and so forth. The first captured dataset CapturedDataset1 124A will have an associated timestamp (version number) indicating a first time point when the first captured dataset CapturedDataset1 124A was generated, and the second captured dataset CapturedDataset2 124B will have an associated timestamp (version number) indicating a second time point when the second captured dataset CapturedDataset2 124B was generated, the second time point being after the first time point.

In some embodiments, the user application 112 can send a rollback request to the OOMD application 122 to rollback the deployed user dataset 114 to a particular prior version of the user dataset 114 at a particular time point. Notably, the user application 112 executing on the user device 110 will typically retain only the current version of the user dataset 114 and not retain prior versions of the user dataset 114. Advantageously, the OODM server 120 retains prior captured datasets 124 of prior versions of the user dataset 114. Therefore, the OOMD application 122 can easily respond to the rollback request by retrieving a prior captured dataset 124 corresponding to the particular prior version of the user dataset 114, followed by performing the conversion phase and the deployment phase based on the prior captured dataset 124. Advantageously, the OODM server 120 can also retain prior converted datasets 134 of prior versions of the user dataset 114. Therefore, the OOMD application 122 can also easily respond to the rollback request by retrieving a prior converted dataset 134 corresponding to the particular prior version of the user dataset 114, followed by performing the deployment phase using the prior converted dataset 134.

In some embodiments, instead of requesting that a new version of the entire user dataset 114 be deployed on a target cluster 140, the user application 112 can request that only the modified/different data between two versions of a user dataset 114 (referred to as the delta between the two versions of the user dataset 114) be deployed to the target cluster 140 instead of an entire new version of a user dataset 114. As the delta can potentially be significantly smaller in data size than the entire new version of a user dataset 114, processing only the delta can significantly reduce usage of computing resources and processing time for the user device 110, OMD server 120, and the target cluster 140. When receiving this delta-deployment request, the OOMD application 122 responds by first generating a current captured dataset 124 for the current version of the user dataset 114, then determining a delta dataset that includes all the data modifications/differences between the current version and a prior version of the user dataset 114 by comparing the current captured dataset 124 and the prior captured dataset 124 corresponding to the prior version of the user dataset 114, and then taking a snapshot of the computed delta dataset to generate a captured delta-dataset. The captured delta-dataset is then processed and treated in a similar manner by the OODM processing pipeline 200 as any other captured dataset 124. Each target cluster 140 is ultimately responsible for integrating the delta dataset into the deployed user dataset 134 and presenting a consistent view of the user dataset 134.

For example, the OOMD application 122 can generate a captured delta-dataset CapturedDeltaDataset1 250 based on a comparison between the second captured dataset CapturedDataset2 124B and the previous first captured dataset CapturedDataset1 124A. The captured delta-dataset CapturedDeltaDataset1 250 will include all the data modifications/differences between the second captured dataset CapturedDataset2 124B and the first captured dataset CapturedDataset1 124A. The captured delta-dataset CapturedDeltaDataset1 250 will then be processed and treated in a similar manner by the OODM processing pipeline 200 as any other captured dataset 124A, 124B, etc.

In the conversion phase 220, the OOMD application 122 processes each captured dataset 124 to generate one or more converted datasets 134. Each converted dataset 134 is generated based on a particular deployment configuration that is defined by a set of deployment parameters. In some embodiments, the deployment parameters include, without limitation, a native format associated with a target cluster 140, a number of desired partitions, a node size of the target cluster 140, desired file size, compression, schema, encoding, resource usage, buffering for peak traffic, and the like. Each different set of deployment parameters defines a different deployment configuration, which produces a different converted dataset 134. Thus, for a same captured dataset 124, applying a different set of deployment parameters to the captured dataset 124 during the conversion phase 220 generates a different converted dataset 134 designed for a different deployment situation. Advantageously, generating different converted datasets 134 for a captured dataset 124 based on different deployment configurations can be performed rapidly and efficiently as the captured dataset 124 is already generated, stored, and available for use, thus making the conversion phase 220 highly reproducible and easily repeatable and independent from the other phases 210 and 230.

For example, for the first captured dataset CapturedDataset1 124A, the OOMD application 122 can generate a first converted dataset ConvertedDataset1 134A and a second converted dataset CapturedDataset2 124B which have different deployment configurations. For example, the first converted dataset ConvertedDataset1 134A can be configured to be deployed in ten partitions across a first target cluster 140 that includes eight target nodes 150, each having a first type of native format. As such, ConvertedDataset1 134A will be divided into ten partitions that are each formatted in the first type of native format. For example, the second converted dataset CapturedDataset2 124B can be configured to be deployed in four partitions across a second target cluster 140 that includes four target nodes 150, each having a second type of native format. As such, ConvertedDataset1 134A will be divided into four partitions that are each formatted in the second type of native format.

The user application 112 can transmit requests for different deployments of the user dataset 114 in different deployment configurations to different clusters 140 for various reasons, such as to compare performance metrics between two different deployments, or to provide redundancy in case of cluster or node failures. In the above example, the first and second clusters 140 can provide redundancy to ensure reliable online access to the underlying user dataset 114 (UserDataset1 114A) in case either target cluster 140 or any of the nodes 150 of the clusters 140 fail or are out-of-service for a period of time. In addition, the performance metrics of the first and second clusters 140 in providing online access to the underlying user dataset 114 (UserDataset1 114A) can be compared to determine which deployment configuration provides better performance. For example, performance metrics can include, without limitation, total deployment time, processor utilization, network usage, disk I/O utilization, read and write latencies, data-specific metrics (such as the number of compaction tasks during and after deployment) and the like. The performance metrics can be measured at the user device 110, OOMD server 120, target cluster 140, and/or client devices 170.

As further shown in FIG. 2, CapturedDeltaDataset1 250 is converted to a third converted dataset ConvertedDataset3 134C based on a particular deployment configuration. Also, CapturedDataset2 124B is converted to a fourth converted dataset ConvertedDataset4 134D, a fifth converted dataset ConvertedDataset5 134E, and a sixth converted dataset ConvertedDataset6 134F, which are each converted based on a different deployment configuration.

In the deployment phase 230, for each converted dataset 134, the OOMD application 122 interacts with the target cluster 140 for the converted dataset 134 to cause the target cluster 140 to deploy and host the converted dataset 134, at which point the converted dataset 134 is referred to as a deployed dataset 144. Since the converted dataset 134 is already formatted in the native format of the target cluster 140, the converted dataset 134 can be rapidly and efficiently deployed on the target cluster 140 using back-end APIs of the target cluster 140 that only need to perform minimal processing operations on the converted dataset 134 to launch/establish the deployed dataset 144 on the target cluster 140. The deployed dataset 144 is then instantly available for online access to client devices 170.

For example, as further shown in the deployment phase 230, ConvertedDataset1 134A can be deployed to a particular target cluster 140 which is then referred to as a first deployed dataset DeployedDataset1 144A, ConvertedDataset2 134B can be deployed to a particular target cluster 140 which is then referred to as a second deployed dataset DeployedDataset2 144B, ConvertedDataset3 134C can be deployed to a particular target cluster 140 which is then referred to as a third deployed dataset DeployedDataset3 144C, ConvertedDataset4 134D can be deployed to a particular target cluster 140 which is then referred to as a fourth deployed dataset DeployedDataset4 144D, ConvertedDataset5 134E can be deployed to a particular target cluster 140 which is then referred to as a fifth deployed dataset DeployedDataset5 144E, and ConvertedDataset6 134F can be deployed to a particular target cluster 140 which is then referred to as a sixth deployed dataset DeployedDataset6 144F.

In some embodiments, a particular converted dataset 134 can be redeployed to a target cluster 140 for various reasons. For example, the prior deployment of the converted dataset 134 to a target cluster 140 may have failed, necessitating the converted dataset 134 to be redeployed to the target cluster 140. As another example, the prior deployment of the converted dataset 134 to a first target cluster 140 may have been successful, but the user application 112 requests deployment of the same converted dataset 134 to a second target cluster 140 for redundancy or to compare performance of the first and second target clusters 140. Advantageously, the OODM server 120 retains prior converted dataset 134 so that any prior converted dataset 134 can be rapidly and efficiently redeployed to a same cluster 140 or different cluster 140 without restarting the processing from the beginning as in prior approaches. As a further example, the user application 112 can send a rollback request to rollback the deployed user dataset 114 to a particular prior version of the user dataset 114 at a particular time point. Advantageously, the OOMD application 122 can easily respond to the rollback request by retrieving the prior converted dataset 134 corresponding to the particular prior version of the user dataset 114, followed by performing the deployment phase. In this manner, redeploying a current or prior converted dataset 134 can be performed rapidly and efficiently as the converted dataset 134 is already generated, stored, and available for use, thus making the deployment phase 230 and highly reproducible and easily repeatable and independent from the other phases 210 and 220.

As discussed above, during the conversion phase 220, the OOMD application 122 converts a captured dataset 124 to generate a converted dataset 134 based on a set of deployment parameters that include the number of desired partitions. In some embodiments, during the conversion phase 220 for a particular converted dataset 134, the OOMD application 122 performs a partitioning process for dividing the converted dataset 134 into a set of partitions, determining a number of target nodes 150 (node size) to be included in the target cluster 140 to be assigned to the converted dataset 134, and assigning each partition in the set of partitions to a target node 150 in the target cluster 140.

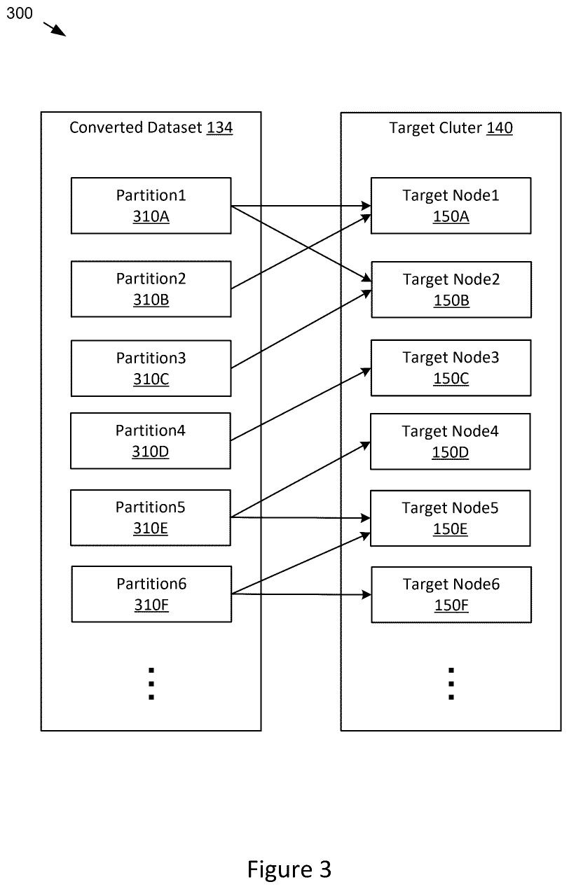

FIG. 3 shows a conceptual illustration of a partitioning process 300 during the conversion phase 220 of the processing pipeline 200 of FIG. 2, according to various embodiments. As shown, the partitioning process 300 includes dividing a converted dataset 134 into one or more partitions 310 (such as 310A, 310B, 310C, etc.). Each partition 310 is a sub-portion of the converted dataset 134. Partitioning the converted dataset 134 for distributing the partitions to different target nodes 150 can be performed to operate a distributed, scalable, fault tolerant system. The fewest number of partitions and target nodes 150 to satisfy the particular deployment situation is ideal, however a larger number of partitions and target nodes 150 may be needed for scaling and/or redundancy. As shown, the partitioning process 300 also includes assigning each partition 310 to at least one target node 150 in the target cluster 140 that is to deploy and host the assigned partition 310. In some embodiments, there can be more than one target node 150 assigned to the same partition 310 for redundancy in case of node failure and to decrease latency/client queues, and there can be multiple partitions 310 assigned to the same target node 150. The OOMD application 122 also generates a manifest file for each converted dataset 134 that specifies the partition-to-node assignments for the converted dataset 134.

After the number of partitions 310 are determined, the OOMD application 122 the converts the captured dataset 124 into a converted dataset 134 that is partitioned/divided into the determined number of partitions 310. During the deployment phase 230, the OOMD application 122 transmits the manifest file to each target node 140 in the target cluster 150, and interacts with each target node 150 to cause the target node 150 to retrieve, deploy, and host at least one assigned partition 310 of the converted dataset 134, at which point the at least one partition of the converted dataset 134 is referred to as at least one partition of a deployed dataset 154. Since each partition 310 of the converted dataset 134 is already formatted in the native format of the target cluster 140, each partition 310 of the converted dataset 134 can be rapidly and efficiently deployed on the assigned target node 150 using back-end APIs of the assigned target node 150 that only need to perform minimal processing operations on the partition 310 of the converted dataset 134 to launch/establish the partition of the deployed dataset 154 on the target node 150. The at least one partition of a deployed dataset 154 is then instantly available for online access to client devices 170.

### OOMD Pipeline Process

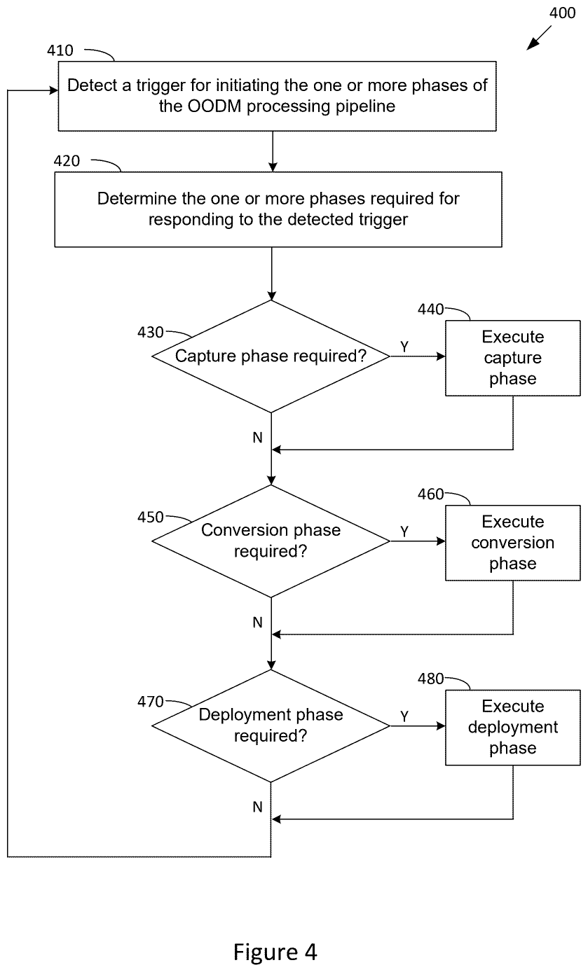

FIG. 4 sets forth a flow diagram of method steps for performing one or more phases of the OODM processing pipeline 200, according to various embodiments. Although the method steps are described with reference to the systems of FIGS. 1-3, persons skilled in the art will understand that any system configured to implement the method steps, in any order, falls within the scope of the embodiments. In some embodiments, the method 400 is executed by the OOMD application 122 executing on the OOMD server 120 that interacts with the user device 110 and/or the target cluster 140 to perform one or more phases 210, 220, and/or 230 of the OODM processing pipeline 200.

As shown, the method 400 begins at step 410, where the OOMD application 122 determines that a trigger for initiating the one or more phases 210, 220, and/or 230 of the OODM processing pipeline 200 has been detected/received. For example, the OOMD application 122 can determine that a current deployment for a particular converted dataset 134 to a particular target cluster 140 has failed, thus requiring a redeployment of the same converted dataset 134 to the same target cluster 140. As another example, the OOMD application 122 can receive a request from the user application 112 executing on the user device 110 to perform some type of action relating to a user dataset 114. For example, the OOMD application 122 can receive, from the user application 112, a deployment request to deploy a particular user dataset 114 onto a particular target cluster 140, a redeployment request to redeploy a particular user dataset 114 in the same deployment configuration onto an additional target cluster 140, a redeployment request to redeploy a particular user dataset 114 in a different deployment configuration onto an additional target cluster 140, a rollback request to rollback the currently deployed user dataset 114 to a particular prior version of the user dataset 114, and the like.

At step 420, the OOMD application 122 determines/selects which particular one or more phases 210, 220, and/or 230 of the OODM processing pipeline 200 are required for fully responding to the trigger detected at step 410. For example, to fully respond to the detected trigger, only one of the phases 210, 220, or 230 may need to be executed, only two of the phases 210, 220, or 230 may need to be executed in sequence, or all three of the phases 210, 220, and 230 may need to be executed in sequence depending on the type of detected trigger. In these embodiments, any of the one or more phases 210, 220, and/or 230 that are not selected at step 420 are not executed by the OOMD application 122 to respond to the trigger detected at step 410.

For example, if the detected trigger comprises determining that the current deployment for a converted dataset 134 to a target cluster 140 has failed, the OOMD application 122 determines that only the deployment phase 230 needs to be executed to redeploy the same converted dataset 134 to the same target cluster 140. As another example, if the detected trigger comprises receiving a redeployment request to redeploy a particular user dataset 114 in the same deployment configuration onto an additional target cluster 140, the OOMD application 122 determines that a converted dataset 134 corresponding to the particular user dataset 114 already exists and is retained from the prior deployment of particular user dataset 114. Thus, the OOMD application 122 determines that only the deployment phase 230 needs to be executed to redeploy the existing converted dataset 134 to the additional target cluster 140.

As another example, if the detected trigger comprises receiving a deployment request to deploy a particular user dataset 114 onto a particular target cluster 140, the OOMD application 122 determines that all three phases 210, 220, and 230 needs to be executed in sequence to generate a captured dataset 124 of the user dataset 114 in the capture phase 210, generate a converted dataset 134 of the captured dataset 124 in the conversion phase 220, and deploy the converted dataset 134 to the target cluster 140 in the deployment phase 230.

As another example, if the detected trigger comprises receiving a deployment request to redeploy a particular user dataset 114 in a different deployment configuration onto an additional target cluster 140, the OOMD application 122 determines that a captured dataset 124 corresponding to the particular user dataset 114 already exists and is retained from the prior deployment of particular user dataset 114. Thus, the OOMD application 122 determines that only two phases 220 and 230 needs to be executed in sequence to generate a new converted dataset 134 from the existing captured dataset 124 based on the different deployment configuration in the conversion phase 220, and deploy the new converted dataset 134 to the additional target cluster 140 in the deployment phase 230.

As another example, if the detected trigger comprises receiving a rollback request to rollback the currently deployed user dataset 114 to a prior user dataset 114, the OOMD application 122 determines that a captured dataset 124 corresponding to the prior user dataset 114 already exists and is retained from the prior deployment of the prior user dataset 114. Thus, the OOMD application 122 determines that only two phases 220 and 230 needs to be executed in sequence to generate a converted dataset 134 from the existing captured dataset 124 in the conversion phase 220, and deploy the converted dataset 134 to the target cluster 140 in the deployment phase 230. In other embodiments, the OOMD application 122 determines that a converted dataset 134 corresponding to the prior user dataset 114 already exists and is retained from the prior deployment of prior user dataset 114. Thus, the OOMD application 122 determines that only the deployment phase 230 needs to be executed to deploy the existing converted dataset 134 to the target cluster 140.

At step 430, the OOMD application 122 determines whether the capture phase 210 is to be executed for responding to the detected trigger. If not, the method 400 continues at step 450. If so, at step 440, the capture phase 210 is executed on a particular user dataset 114 specified in the detected trigger to generate a captured dataset 124. The method 400 then continues at step 450.

At step 450, the OOMD application 122 determines whether the conversion phase 220 is to be executed for responding to the detected trigger. If not, the method 400 continues at step 470. If so, at step 460, the conversion phase 220 is executed a particular captured dataset 124 based on a particular deployment configuration specified in the detected trigger to generate a converted dataset 134. The method 400 then continues at step 450.

At step 470, the OOMD application 122 determines whether the deployment phase 230 is to be executed for responding to the detected trigger. If not, the method 400 continues at step 410. If so, at step 480, the deployment phase 230 is executed to deploy a particular converted dataset 134 on a particular target node 150 specified in the detected trigger to produce a deployed dataset 144 on the particular target node 150. The method 400 then continues at step 410.

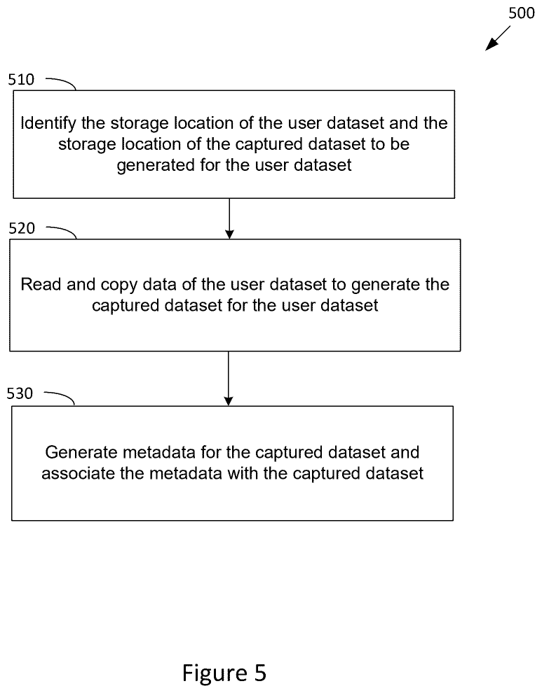

FIG. 5 sets forth a flow diagram of method steps for performing the capture phase 210 of the OODM processing pipeline 200, according to various embodiments. Although the method steps are described with reference to the systems of FIGS. 1-3, persons skilled in the art will understand that any system configured to implement the method steps, in any order, falls within the scope of the embodiments. In some embodiments, the method 500 is executed by the OOMD application 122 executing on the OOMD server 120 that interacts with the user device 110 to perform the capture phase 210 of the OODM processing pipeline 200. The method 500 can comprise step 440 of the method 400 of FIG. 4, whereby the OOMD application 122 has already received from the user device 110 a request for an action relating to a specified user dataset 114 and determined that the requested action requires performing the capture phase 210 on the specified user dataset 114.

As shown, the method 500 begins at step 510, where the OOMD application 122 identifies the storage location of the specified user dataset 114 and the storage location where the captured dataset 124 to be generated for the user dataset 114 will be stored. The user dataset 114 can be stored locally on the user device 110 or stored remotely on cloud storage 160. The storage location of the user dataset 114 can be specified in the user request. The captured dataset 124 can be stored locally on the OOMD server 120 or stored remotely on cloud storage 160.

At step 520, the OOMD application 122 reads data from the storage location of the user dataset 114 and copies the data to the storage location of the captured dataset 124 to generate the captured dataset 124 for the user dataset 114. In some embodiments, the OOMD application 122 can implement a Spark cluster comprising a type of data query or execution platform that interacts with APIs of the user device 110 or cloud storage 160 that stores the user dataset 114 to read data from the user dataset 114 and copy the data to the captured dataset 124. In some embodiments, the captured dataset 124 is in the same type of format as the user dataset 114. For example, Iceberg tables can be read from the user dataset 114 and written to the captured dataset 124 as Iceberg tables. Advantageously, the user device 110 will have control over the user dataset 114 and continue to modify the user dataset 114 over time, whereas the OOMD server 120 will have control over the captured dataset 124 which will not be modified over time and comprises an immutable snapshot copy of the user dataset 114 at the point in time the captured dataset 124 is generated.

At step 530, the OOMD application 122 generates metadata for the generated captured dataset 124 and associates the metadata with the captured dataset 124. The metadata can include, without limitation, a timestamp, version number, file size, storage location of the corresponding user dataset 114, and the like. The timestamp indicates the day/time when the user dataset 114 was captured and the captured dataset 124 was generated. In some embodiments, a version number of the captured dataset 124 can include or be based on the timestamp of the captured dataset 124. The method 500 then ends.

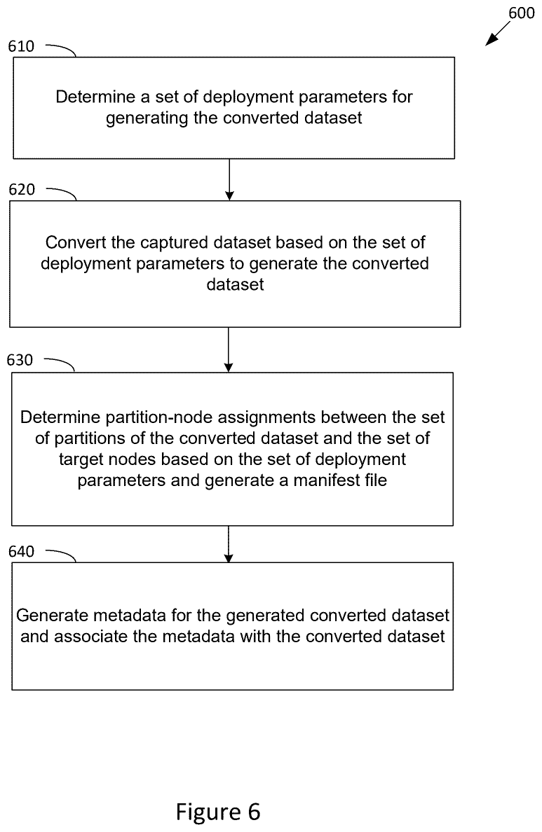

FIG. 6 sets forth a flow diagram of method steps for performing the conversion phase 220 of the OODM processing pipeline 200, according to various embodiments. Although the method steps are described with reference to the systems of FIGS. 1-3, persons skilled in the art will understand that any system configured to implement the method steps, in any order, falls within the scope of the embodiments. In some embodiments, the method 600 is executed by the OOMD application 122 executing on the OOMD server 120. The method 600 can comprise step 460 of the method 400 of FIG. 4, whereby the OOMD application 122 has already received from the user device 110 a request for an action relating to a specified captured dataset 124 and determined that the requested action requires performing the conversion phase 220 on the specified captured dataset 124 to generate a converted dataset 134.

As shown, the method 600 begins at step 610, where the OOMD application 122 determines a set of deployment parameters (deployment configuration) for generating the converted dataset 134. In some embodiments, the set of deployment parameters include, without limitation, a native format associated with a target cluster 140, a number of desired partitions, a node size of the target cluster 140, desired file size, compression, schema, encoding, resource usage, or buffering for peak traffic, or any combination thereof.

The native format of the target cluster 140 comprises the native dataset/database format implemented by the set of target nodes 150 of the target cluster 140 for configuring and storing datasets. The native format of a target node 150 comprises an internal data representation and storage structure that the target node 150 uses to persist, manage, and retrieve data with maximum efficiency. For example, native formats that can be used with target nodes 150 include Apache Cassandra, RocksDB, SQLite3, Hollow, any variety of Sorted String Table (SSTable) format, any variety of key-value format, or any other type of dataset/database format.

The number of partitions for the converted dataset 134 is determined so as to distribute partitions to different target nodes 150 to provide a distributed, scalable, fault tolerant system. The fewest number of partitions and target nodes 150 to satisfy the particular deployment situation is ideal, however a larger number of partitions and target nodes 150 may be needed for scaling and/or redundancy. The partitioning goals include creating enough partitions to distribute across enough target nodes 150, but not to have too many partitions as this adds to the cost and complexity of metadata required to describe the location and properties of the resulting user dataset 114. Partitioning is typically performed in multiples of 2, and defaults at 256, although any number of partitions can be used.

At step 620, the OOMD application 122 converts the captured dataset 124 based on the set of deployment parameters (deployment configuration) determined at step 610 to generate the converted dataset 134. Notably, the user dataset 114 and captured dataset 124 are typically in a format that is different from the native format of the target cluster 140. Thus, step 620 can include converting the format of the captured dataset 124 to the native format of the target cluster 140. For example, if the captured dataset 124 comprises Iceberg tables and the native format of the target cluster 140 comprises RocksDB, the OOMD application 122 can transform the Iceberg tables into serialized RocksDB-formatted SSTables. For example, if the captured dataset 124 comprises Iceberg tables and the native format of the target cluster 140 comprises Apache Cassandra, the OOMD application 122 can transform the Iceberg tables into serialized Cassandra-formatted SSTables. Step 620 also includes partitioning the converted dataset 134 into the number of partitions specified in the set of deployment parameters. Partitioning of the converted dataset 134 can be achieved using various techniques, including implementing a hashing function, such as xxHash64 any other hashing function compatible with the target datastores. The converted dataset 134 (comprising a set of partitions) is then stored locally on the OOMD server 120 or stored remotely on cloud storage 160.

At step 630, the OOMD application 122 determines partition-node assignments between the set of partitions of the converted dataset 134 and the set of target nodes 150 of the target cluster 140 based on the set of deployment parameters (deployment configuration) determined at step 610. The partition-node assignments specify, for each partition of the converted dataset 134, at least one target node 150 in the target cluster 140 that is assigned to deploy and host the partition. The OOMD application 122 also generates a manifest file that specifies the partition-to-node assignments for the converted dataset 134 and a storage location for each partition of the converted dataset 134 (stored locally on the OOMD server 120 or stored remotely on cloud storage 160). The partition-node assignments is a mapping between partitions and target nodes such that the entire dataset converted dataset 134 is addressable.

At step 640, the OOMD application 122 generates metadata for the generated converted dataset 134 and associates the metadata with the converted dataset 134. The metadata can include, without limitation, a set of deployment parameters, a timestamp, file size, storage location of the corresponding captured dataset 124, and the like. The set of deployment parameters comprises the corresponding deployment configuration used to generate the converted dataset 134. The timestamp indicates the day/time when the converted dataset 134 was generated. The method 600 then ends.

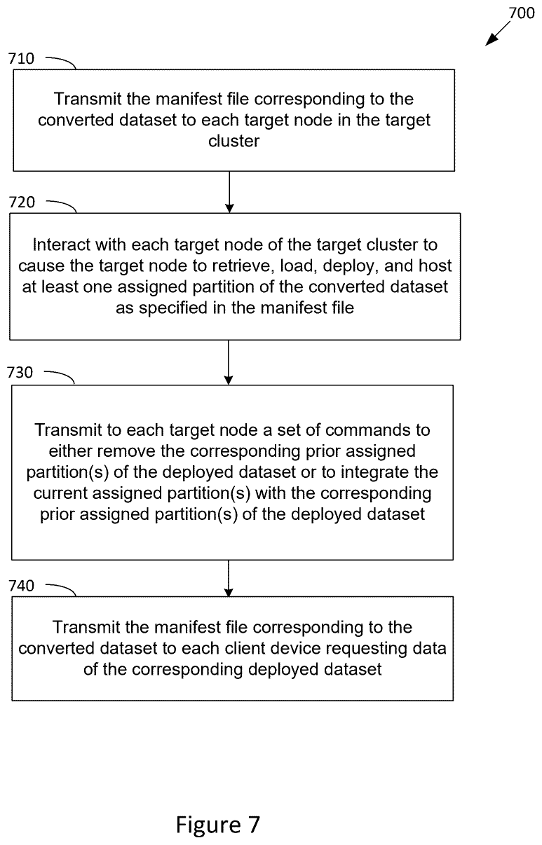

FIG. 7 sets forth a flow diagram of method steps for performing the deployment phase 230 of the OODM processing pipeline 200, according to various embodiments. Although the method steps are described with reference to the systems of FIGS. 1-3, persons skilled in the art will understand that any system configured to implement the method steps, in any order, falls within the scope of the embodiments. In some embodiments, the method 700 is executed by the OOMD application 122 executing on the OOMD server 120 that interacts with the set of target nodes 150 of the target cluster 140 to perform the deployment phase 230 of the OODM processing pipeline 200. The method 700 can comprise step 480 of the method 400 of FIG. 4, whereby the OOMD application 122 has already received from the user device 110 a request for an action relating to a converted dataset 134 and determined that the requested action requires performing the deployment phase 230 on the converted dataset 134 to establish a deployed dataset 144 on a set of target nodes 150 of a target cluster 140.

As shown, the method 700 begins at step 710, where the OOMD application 122 transmits the manifest file corresponding to the converted dataset 134 to each target node 150 in the target cluster 140. For each target node 150 receiving the manifest file, the manifest file specifies each partition of the converted dataset 134 assigned to be hosted by the target node 150, and a storage location for each assigned partition of the converted dataset 134 (stored locally on the OOMD server 120 or stored remotely on cloud storage 160).

At step 720, the OOMD application 122 interacts with each target node 150 of the target cluster 140 to cause the target node 150 to retrieve, load, deploy, and host at least one assigned partition 310 of the converted dataset 134 as specified in the manifest file. In particular, the OOMD application 122 can transmit a set of commands to the target node 150 to retrieve the assigned partition(s) from the corresponding storage locations, load the assigned partition(s) to storage locations controlled by the target node 150, deploy the assigned partition(s) on the target node 150, and begin hosting the assigned partition(s) on the target node 150. In some embodiments, set of commands transmitted to the target node 150 specify that the back-end APIs of the target node 150 are to be used to execute the set of commands and the front-end APIs of the target node 150 are not to be used to execute the set of commands.

In response, the target node 150 executes the set of commands to deploy and host the assigned partition(s) of the converted dataset 134. In some embodiments, the node application 152 executing on the target node 150 can execute the set of commands using back-end APIs. To retrieve the assigned partition(s), the node application 152 can retrieve the partition file(s) corresponding to the assigned partition(s) from the corresponding storage locations. To load the assigned partition(s), the node application 152 can store and map the partition(s) to namespaces in storage locations controlled by the node application 152 (such as stored locally on the target node 150 or stored remotely on cloud storage 160). To deploy the assigned partition(s), the node application 152 can bring the assigned partition(s) online and make the data of the assigned partition(s) accessible to clients 170. To host the assigned partition(s), the node application 152 can respond to requests from clients 170 for data of the assigned partition(s).

Since the assigned partition(s) are already formatted in the native format of the target cluster 140, the assigned partition(s) can be rapidly and efficiently loaded and deployed on the assigned target node 150 using back-end APIs of the assigned target node 150 that only needs to perform minimal processing operations on the assigned partition(s) to load and deploy the partition on the target node 150. Advantageously, the node application 152 implements back-end APIs rather than front-end APIs to load and deploy the assigned partition(s). As used in prior approaches, front-end APIs are configured for processing data updates or modifications to single records in a table of a dataset, processing one record at a time for the dataset (record-by-record updating). In contrast, back-end APIs are configured for processing large datasets in bulk rather than record-by-record processing of individual records. Thus, processing a large dataset such as a converted dataset 134 using back-end APIs rather than front-end APIs result is in lower consumption of computing resources and time for each target node 150. In addition, front-end APIs are typically configured for interacting with client devices 170 and servicing client requests for data on deployed datasets. Thus, by using the back-end APIs and without using the front-end APIs of the target node 150 for loading and deploying the assigned partition(s), the front-end APIs of the target node 150 can continue servicing client requests for data on deployed datasets without significant slowdown or interference.

At step 730, the OOMD application 122 transmits, to each target node 150 of the target cluster 140, a set of commands to either remove the corresponding prior assigned partition(s) of the deployed dataset 154 or to integrate the current assigned partition(s) with the corresponding prior assigned partition(s) of the deployed dataset 154. If the user request specified that the entire user dataset 114 be loaded and deployed to the target cluster 140, this indicates that the user wishes to do a full and new replacement of the entire user dataset 114 on the target cluster 140 without use of incremental updating of the previous user dataset 114 based on a delta-dataset. Thus, in this situation, the set of commands includes commands to remove the corresponding prior assigned partition(s) of the deployed dataset 154 from the target node 150. If the user request specified that only a delta be loaded and deployed to the target cluster 140, this indicates that the user wishes to do an incremental update of the previous user dataset 114 based on a delta-dataset between the previous user dataset 114 and the current user dataset 114. Thus, in this situation, the set of commands includes commands to integrate the current assigned partition(s) with the corresponding prior assigned partition(s) of the deployed dataset 154.

At step 740, the OOMD application 122 transmits the manifest file corresponding to the converted dataset 134 to each client device 170 that requests data of the corresponding deployed dataset 144. Thus, each client device 170 has the information necessary to direct requests towards the appropriate target nodes 150 of the target cluster 140. In particular, the client application 172 executing on the client device 170 enables communication between the client device 170 and the target nodes 150 by handling the routing and processing of requests for data of the deployed dataset 144 using the manifest file as a coordinating element. The method 700 then ends.

### Computing Device Overview

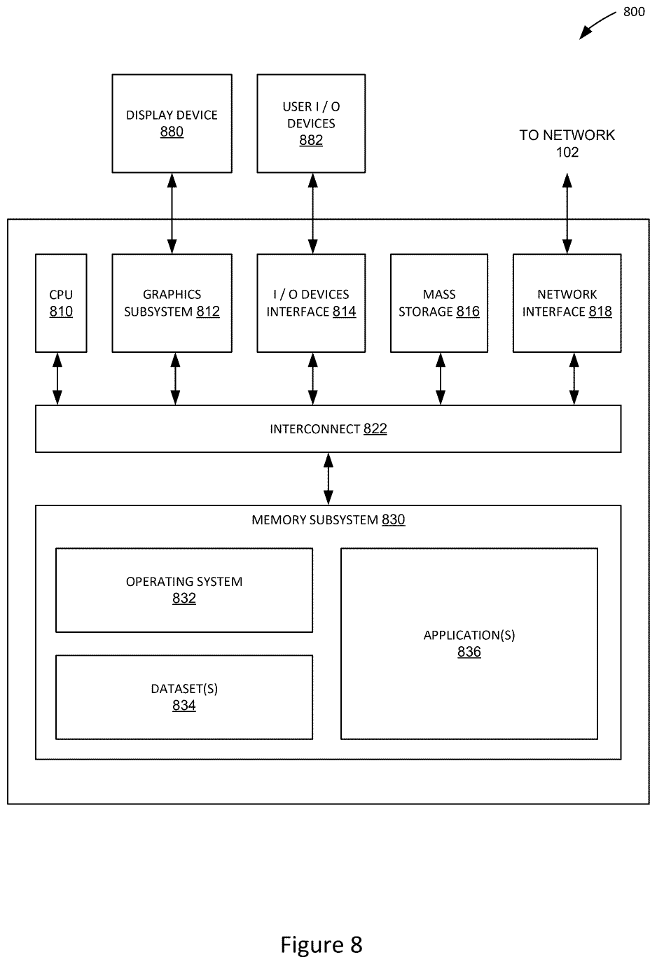

FIG. 8 is a conceptual illustration of a computing device 800 that can be used to implement any of the computing devices shown in FIG. 1, according to various embodiments. The computing device 800 can comprise the user device 110, the OOMD server 120, the target node 150, the cloud storage 160, or the client device 170. As shown, the computing device 800 can include, without limitation, a CPU 810, a graphics subsystem 812, an I/O device interface 814, a mass storage unit 816, a network interface 818, an interconnect 822, a memory subsystem 830, a display device 880, and user I/O devices 882.

In some embodiments, the CPU 810 is configured to retrieve and execute programming instructions stored in the memory subsystem 830. Similarly, the CPU 810 is configured to store and retrieve application data (e.g., software libraries) residing in the memory subsystem 830. The interconnect 822 is configured to facilitate transmission of data, such as programming instructions and application data, between the CPU 810, graphics subsystem 812, I/O devices interface 814, mass storage 816, network interface 818, and memory subsystem 830.

In some embodiments, the graphics subsystem 812 is configured to generate frames of video data and transmit the frames of video data to display device 880. In some embodiments, the graphics subsystem 812 can be integrated into an integrated circuit, along with the CPU 810. The display device 880 can comprise any technically feasible means for generating an image for display. For example, the display device 880 can be fabricated using liquid crystal display (LCD) technology, cathode-ray technology, and light-emitting diode (LED) display technology. An input/output (I/O) device interface 814 is configured to receive input data from user I/O devices 882 and transmit the input data to the CPU 810 via the interconnect 822. For example, user I/O devices 882 can comprise one of more buttons, a keyboard, and a mouse or other pointing device. The I/O device interface 814 also includes an audio output unit configured to generate an electrical audio output signal. User I/O devices 882 includes a speaker configured to generate an acoustic output in response to the electrical audio output signal. In alternative embodiments, the display device 880 can include the speaker. A television is an example of a device known in the art that can display video frames and generate an acoustic output.

A mass storage unit 816, such as a hard disk drive or flash memory storage drive, is configured to store non-volatile data. A network interface 818 is configured to transmit and receive packets of data via the communications network 102. In some embodiments, the network interface 818 is configured to communicate using the well-known Ethernet standard. The network interface 818 is coupled to the CPU 810 via the interconnect 822.

In some embodiments, the memory subsystem 830 includes programming instructions and application data that comprise an operating system 832, one or more datasets 834, and one or more applications 836. The operating system 832 performs system management functions such as managing hardware devices including the network interface 818, mass storage unit 816, I/O device interface 814, and graphics subsystem 812. The operating system 832 also provides process and memory management models for the dataset(s) 834 and the application(s) 836. Persons skilled in the art will recognize the various operating systems that are well-known in the art and suitable for incorporation into the various computing devices of FIG. 1.

Depending on the implementation of the computing device 800 as a user device 110, OOMD server 120, target node 150, or cloud storage 160, the dataset(s) 834 can include a user dataset 114, captured dataset 124, converted dataset 134, a deployed dataset 144, or any combination thereof. Depending on the implementation of the computing device 800 as a user device 110, OOMD server 120, target node 150, cloud storage 160, or client device 170, the application(s) 836 can include a user application 112, OOMD application 122, node application 152, or a client application 172.

It will be appreciated that the user device 110, the OOMD server 120, the target node 150, the cloud storage 160, or the client device 170 described above in conjunction with FIGS. 1 and 8 are illustrative, and that variations and modifications are possible. The connection topologies, including the number of CPUs and memories, may be modified as desired, and, in certain embodiments, one or more components shown in FIGS. 1 and 8 may not be present. Further, in certain embodiments, one or more components shown in FIGS. 1 and 8 may be implemented as virtualized resources in a virtual computing environment and/or a cloud computing environment.

In sum, the disclosed techniques set forth an offline to online data movement (OODM) system for efficiently moving offline-generated user datasets to online datastores that are accessible by clients. The offline-generated user datasets are not accessible to client devices via a network, whereas the online datastores (target clusters) have network accessibility for client devices. The OODM system includes an OODM server executing an OODM application. The OODM application interacts, via a network, with both a user device associated with a user dataset and a cluster of target nodes. The cluster of target nodes deploys the user dataset to provide online access to clients. The OODM server facilitates a processing pipeline between the user device and the cluster of target nodes to capture and convert the user dataset, thereby promoting rapid and efficient deployment of the user dataset on the cluster of target nodes. The OODM application provides a processing pipeline that conducts three separate and independent phases, including a capture phase, conversion phase, and deployment phase. During the capture phase, the OODM application interacts with the user device to capture an immutable (read-only) snapshot of the user database, which results in a captured dataset. In the conversion phase, the OODM application converts the captured dataset to the native format of the cluster of target nodes, which results in a converted dataset. During the deployment phase, the OODM application interacts with the cluster of target nodes using back-end APIs. This interaction serves to deploy the converted dataset on the cluster, thereby providing a deployed dataset that clients can access via a network. The three phases can be performed automatically, or each phase can be performed separately and independently if needed.

One technical advantage of the disclosed techniques relative to the prior art is that the disclosed techniques significantly reduce the processing workload and time required by the user device and the cluster in moving the offline user dataset to an online cluster. In particular, the OODM server interacts with the user device only to capture a snapshot image of the user dataset, which requires negligible computing resources and time of the user device. The OODM server then performs the processing-intensive conversion of the captured dataset to the native format of the cluster without requiring any processing or interactions by the user device or the cluster. Since the user dataset is already converted to the native format of the cluster, the converted dataset can be rapidly and efficiently deployed to the cluster with minimal additional processing by the back-end APIs of the cluster. As such, the workload on the cluster is greatly reduced relative to prior approaches so that the cluster can perform its base functions serving other datasets to clients without interference and slowdown.

Another technical advantage of the disclosed techniques relative to the prior art is that the disclosed techniques provide a processing pipeline that does not require all three phases to be performed sequentially, thereby allowing each separate phase to be performed independently and repeatedly when needed. This flexibility is valuable for generating snapshots of different versions of a user dataset at varying points in time, converting a captured dataset to a different native format, or deploying a converted dataset to another cluster. Another technical advantage of the disclosed techniques relative to the prior art is that the disclosed techniques provide the ability to independently perform the deployment phase, thereby enabling the redeployment of a converted dataset to the same cluster upon failure of a previous deployment, without restarting the data movement process as required in prior approaches. Another technical advantage of the disclosed techniques relative to the prior art is that the disclosed techniques capture and retain different versions of a user dataset at different points in time, thereby providing rapid and efficient rollback to a prior version of a user dataset if errors are found in a current version.

Aspects of the subject matter described herein are set out in the following numbered clauses.
1. In some embodiments, a computer-implemented method for deploying offline datasets for online access comprises generating, at a server device, a captured dataset based on a user dataset of a user device, wherein the captured dataset is configured in a first format, generating, at the server device, a converted dataset based on the captured dataset, wherein the converted dataset is configured in a second format, and causing, at the server device, the converted dataset to be deployed on a target cluster having a native format comprising the second format, wherein the server device is separate from the user device and the target cluster.
2. The computer-implemented method of clause 1, wherein the captured dataset comprises a read-only snapshot image of the user dataset.
3. The computer-implemented method of clauses 1 or 2, wherein the converted dataset is deployed on the target cluster as a deployed dataset that is accessible to a client device via a network.
4. The computer-implemented method of any of clauses 1-3, wherein causing the converted dataset to be deployed on the target cluster comprises causing the target cluster to implement back-end application programming interfaces (APIs) to deploy the converted dataset on the target cluster.
5. The computer-implemented method of any of clauses 1-4, further comprising causing the converted dataset to be deployed on an additional target cluster having a native format comprising the second format.
6. The computer-implemented method of any of clauses 1-5, wherein the converted dataset is generated further based on a first deployment configuration, the method further comprising generating an additional converted dataset based on the captured dataset and a second deployment configuration, and causing the additional converted dataset to be deployed on an additional target cluster.
7. The computer-implemented method of any of clauses 1-6, wherein the first deployment configuration specifies the second format, the second deployment configuration specifies a third format that is different from the second format, and the additional target cluster has a native format comprising the third format.
8. The computer-implemented method of any of clauses 1-7, wherein the first deployment configuration specifies a first number of partitions, the second deployment configuration specifies a second number of partitions that is different from the first number of partitions, and the additional target cluster has a native format comprising the second format.
9. The computer-implemented method of any of clauses 1-8, further comprising receiving, from the user device, a rollback request associated with a prior user dataset, retrieving a prior converted dataset corresponding to the prior user dataset, wherein the prior converted dataset is configured in the second format, and causing the prior converted dataset to be deployed on the target cluster.
10. The computer-implemented method of any of clauses 1-9, wherein the converted dataset comprises a set of partitions and the target cluster comprises a set of target nodes, the method further comprising determining partition to node assignments comprising assigning each partition in the set of partitions to at least one target node in the set of target nodes, transmitting a manifest file that includes the partition to node assignments to a first target node in the set of target nodes, and causing the first target node to load and deploy a first partition in the set of partitions that is assigned to the first target node.
11. In some embodiments, one or more non-transitory computer readable media store instructions that, when executed by one or more processors, cause the one or more processors to deploy offline datasets for online access, by performing the steps of generating, at a server device, a captured dataset based on a user dataset of a user device, wherein the captured dataset is configured in a first format, generating, at the server device, a converted dataset based on the captured dataset, wherein the converted dataset is configured in a second format, and causing, at the server device, the converted dataset to be deployed on a target cluster having a native format comprising the second format, wherein the server device is separate from the user device and the target cluster.
12. The one or more non-transitory computer readable media of clause 11, wherein the captured dataset comprises a read-only snapshot image of the user dataset.
13. The one or more non-transitory computer readable media of clauses 11 or 12, wherein the converted dataset is deployed on the target cluster as a deployed dataset that is accessible to a client device via a network, wherein the user dataset is not accessible to the client device via the network.
14. The one or more non-transitory computer readable media of any of clauses 11-13, wherein causing the converted dataset to be deployed on the target cluster comprises causing the converted dataset to be deployed on the target cluster without implementing front-end application programming interfaces (APIs).
15. The one or more non-transitory computer readable media of any of clauses 11-14, further comprising causing the converted dataset to be deployed on an additional target cluster having a native format comprising the second format.
16. The one or more non-transitory computer readable media of any of clauses 11-15, wherein the converted dataset is generated further based on a first deployment configuration, the method further comprising generating an additional converted dataset based on the captured dataset and a second deployment configuration, and causing the additional converted dataset to be deployed on an additional target cluster.
17. The one or more non-transitory computer readable media of any of clauses 11-16, wherein the first deployment configuration specifies the second format, the second deployment configuration specifies a third format that is different from the second format, and the additional target cluster has a native format comprising the third format.
18. The one or more non-transitory computer readable media of any of clauses 11-17, wherein the first deployment configuration specifies a first number of partitions, the second deployment configuration specifies a second number of partitions that is different from the first number of partitions, and the additional target cluster has a native format comprising the second format.
19. The one or more non-transitory computer readable media of any of clauses 11-18, further comprising receiving, from the user device, a rollback request associated with a prior user dataset, retrieving a prior captured dataset corresponding to the prior user dataset, generating an additional converted dataset based on the prior captured dataset, wherein the additional converted dataset is configured in the second format, and causing the additional converted dataset to be deployed on the target cluster.
20. In some embodiments, a server device comprises one or more memories that include instructions, and one or more processors that are coupled to the one or more memories and, when executing the instructions, are configured to deploy offline datasets for online access, by performing the operations of generating a captured dataset based on a user dataset of a user device, wherein the captured dataset is configured in a first format, generating a converted dataset based on the captured dataset, wherein the converted dataset is configured in a second format, and causing the converted dataset to be deployed on a target cluster having a native format comprising the second format, wherein the server device is separate from the user device and the target cluster.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for deploying offline datasets for online access, the method comprising:
generating, at a server device, a captured dataset based on a user dataset of a user device, wherein the captured dataset is configured in a first format;
generating, at the server device, a converted dataset based on the captured dataset, wherein the converted dataset is configured in a second format; and
causing, at the server device, the converted dataset to be deployed on a target cluster having a native format comprising the second format, wherein the server device is separate from the user device and the target cluster.

2. The computer-implemented method of claim 1, wherein the captured dataset comprises a read-only snapshot image of the user dataset.

3. The computer-implemented method of claim 1, wherein the converted dataset is deployed on the target cluster as a deployed dataset that is accessible to a client device via a network.

4. The computer-implemented method of claim 1, wherein causing the converted dataset to be deployed on the target cluster comprises causing the target cluster to implement back-end application programming interfaces (APIs) to deploy the converted dataset on the target cluster.

5. The computer-implemented method of claim 1, further comprising causing the converted dataset to be deployed on an additional target cluster having a native format comprising the second format.

6. The computer-implemented method of claim 1, wherein the converted dataset is generated further based on a first deployment configuration, the method further comprising:
generating an additional converted dataset based on the captured dataset and a second deployment configuration; and
causing the additional converted dataset to be deployed on an additional target cluster.

7. The computer-implemented method of claim 6, wherein the first deployment configuration specifies the second format, the second deployment configuration specifies a third format that is different from the second format, and the additional target cluster has a native format comprising the third format.

8. The computer-implemented method of claim 6, wherein the first deployment configuration specifies a first number of partitions, the second deployment configuration specifies a second number of partitions that is different from the first number of partitions, and the additional target cluster has a native format comprising the second format.

9. The computer-implemented method of claim 1, further comprising:
receiving, from the user device, a rollback request associated with a prior user dataset;
retrieving a prior converted dataset corresponding to the prior user dataset, wherein the prior converted dataset is configured in the second format; and
causing the prior converted dataset to be deployed on the target cluster.

10. The computer-implemented method of claim 1, wherein the converted dataset comprises a set of partitions and the target cluster comprises a set of target nodes, the method further comprising:
determining partition to node assignments comprising assigning each partition in the set of partitions to at least one target node in the set of target nodes;
transmitting a manifest file that includes the partition to node assignments to a first target node in the set of target nodes; and
causing the first target node to load and deploy a first partition in the set of partitions that is assigned to the first target node.

11. One or more non-transitory computer readable media storing instructions that, when executed by one or more processors, cause the one or more processors to deploy offline datasets for online access, by performing the steps of:
generating, at a server device, a captured dataset based on a user dataset of a user device, wherein the captured dataset is configured in a first format;
generating, at the server device, a converted dataset based on the captured dataset, wherein the converted dataset is configured in a second format; and
causing, at the server device, the converted dataset to be deployed on a target cluster having a native format comprising the second format, wherein the server device is separate from the user device and the target cluster.

12. The one or more non-transitory computer readable media of claim 11, wherein the captured dataset comprises a read-only snapshot image of the user dataset.

13. The one or more non-transitory computer readable media of claim 11, wherein the converted dataset is deployed on the target cluster as a deployed dataset that is accessible to a client device via a network, wherein the user dataset is not accessible to the client device via the network.

14. The one or more non-transitory computer readable media of claim 11, wherein causing the converted dataset to be deployed on the target cluster comprises causing the converted dataset to be deployed on the target cluster without implementing front-end application programming interfaces (APIs).

15. The one or more non-transitory computer readable media of claim 11, further comprising causing the converted dataset to be deployed on an additional target cluster having a native format comprising the second format.

16. The one or more non-transitory computer readable media of claim 11, wherein the converted dataset is generated further based on a first deployment configuration, the method further comprising:
generating an additional converted dataset based on the captured dataset and a second deployment configuration; and
causing the additional converted dataset to be deployed on an additional target cluster.

17. The one or more non-transitory computer readable media of claim 16, wherein the first deployment configuration specifies the second format, the second deployment configuration specifies a third format that is different from the second format, and the additional target cluster has a native format comprising the third format.

18. The one or more non-transitory computer readable media of claim 16, wherein the first deployment configuration specifies a first number of partitions, the second deployment configuration specifies a second number of partitions that is different from the first number of partitions, and the additional target cluster has a native format comprising the second format.

19. The one or more non-transitory computer readable media of claim 11, further comprising:
receiving, from the user device, a rollback request associated with a prior user dataset;
retrieving a prior captured dataset corresponding to the prior user dataset;
generating an additional converted dataset based on the prior captured dataset, wherein the additional converted dataset is configured in the second format; and
causing the additional converted dataset to be deployed on the target cluster.

20. A server device, comprising:
one or more memories that include instructions; and
one or more processors that are coupled to the one or more memories and, when executing the instructions, are configured to deploy offline datasets for online access, by performing the operations of:
generating a captured dataset based on a user dataset of a user device, wherein the captured dataset is configured in a first format;
generating a converted dataset based on the captured dataset, wherein the converted dataset is configured in a second format; and
causing the converted dataset to be deployed on a target cluster having a native format comprising the second format, wherein the server device is separate from the user device and the target cluster.
